(19) United States
(12) Patent Application Publication
(10) Pub. No.: US 2024/0109094 A1
(43) Pub. Date: Apr. 4, 2024

(54) AGRICULTURAL SPRAYER CLEANING SYSTEMS AND METHODS FOR SAME

(71) Applicant: Raven Industries, Inc., Sioux Falls, SD (US)

(72) Inventors: Nicholas O. Michael, Sioux Falls, SD (US); Jared Ernest Kocer, Sioux Falls, SD (US); Jesse Lee Wagers, Harrisburg, SD (US)

(21) Appl. No.: 18/481,181

(22) Filed: Oct. 4, 2023

Related U.S. Application Data
(60) Provisional application No. 63/413,154, filed on Oct. 4, 2022.

(51) Int. Cl. B05B 15/58; A01M 7/00; B05B 9/04

(52) U.S. Cl. CPC B05B 15/58; A01M 7/0042; A01M 7/0089; B05B 9/0403

(57) ABSTRACT

An agricultural sprayer cleaning assembly includes a cleaning agent reservoir configured to contain a cleaning agent. The agricultural sprayer cleaning assembly includes a cleaning configuration. In an application configuration a boom tube and sprayer nozzles are in communication with an agricultural product reservoir and are isolated from the cleaning agent reservoir. In a cleaning configuration one or more of the boom tube, the sprayer nozzles or the agricultural product reservoir are in communication with the cleaning agent reservoir, and the cleaning agent is circulated through the boom tube.

### RELATED MATTERS

This patent application claims the benefit under 35 U.S.C. § 119(e) of U.S. Provisional Patent Application 63/413,154, filed Oct. 4, 2022, the disclosure of which is hereby incorporated by reference herein in its entirety. This patent application is related to Wagers et al., U.S. Provisional Patent Application Ser. No. 62/767,280, entitled “SPRAYER BOOM RECIRCULATION AND MIXING SYSTEMS AND METHODS FOR SAME” filed on Nov. 14, 2018 (Attorney Docket No. 2754.256PRV); Wagers et al., PCT Patent Application Number PCT/US2019/061563, entitled “SPRAYER BOOM RECIRCULATION AND MIXING SYSTEMS AND METHODS FOR SAME” filed on Nov. 14, 20219 (Attorney Docket No. 2754.256WO1); and Wagers et al., U.S. patent application Ser. No. 17/293,843, entitled “SPRAYER BOOM RECIRCULATION AND MIXING SYSTEMS AND METHODS FOR SAME” filed on May 13, 2021 (Attorney Docket No. 2754.256US1), all of which are hereby incorporated by reference herein in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc. of Sioux Falls, South Dakota. All Rights Reserved.

### TECHNICAL FIELD

This document pertains generally, but not by way of limitation, to agricultural sprayers and application of agricultural products.

### BACKGROUND

Agricultural sprayers transport and dispense mixed solutions of agricultural products to crops through a plurality of spray nozzles. In some examples, agricultural sprayers include a supply tank including a carrier fluid mixed with one or more agricultural products (e.g., fertilizer, herbicide, pesticide or the like) to provide an agricultural solution. A system pump draws from the supply tank and pumps the agricultural solution into sprayer boom tubes (e.g., provided along booms extending from the vehicle). The agricultural solution is pumped from a proximal end of each boom tube to an opposed distal end and dispensed from spray nozzles provided along the length of the booms between the ends.

In other examples, sprayers include a supply tank having the carrier fluid, and one or more separate reservoirs including agricultural products. The one or more agricultural products are mixed with the carrier fluid onboard the sprayer vehicle. The system pump moves the mixed agricultural solution into the boom tubes for dispensing through spray nozzles.

In practice, upon completion of an agricultural spraying operation the operator drives the sprayer to a reclamation site and the remaining agricultural product is drained from the system. To remove residual agricultural product the operator manually pours a cleaning agent into the sprayer system and flushes the cleaning agent through the system. The flushed cleaning agent is optionally delivered through the spray nozzles to remove residual agricultural product from the system through the spray nozzles.

### OVERVIEW

The present inventors have recognized, among other things, that a problem to be solved includes efficiently and thoroughly cleaning agricultural products from agricultural sprayers after conducting spraying operations. In some examples, after a spraying operation is complete the operator drives the sprayer to a reclamation site (e.g., away from the field, for instance at a farm or municipal site) and at the site a majority of the remaining agricultural product is drained or vacuumed from the system. Residual agricultural product remains (e.g., incidental product remains in plumbing, fittings, nozzles or the like). In one example, the operator administers a cleaning agent, such as a neutralizing agent into the sprayer system. The cleaning agent removes residual agricultural product to ensure reactions between the residue and a later administered (and optionally different) agricultural product are minimized. The operator judges the amount of neutralizing agent based on experience and in some examples an estimate of the volume of the sprayer system plumbing. In some examples, the operator makes a ‘best guess’ regarding the quantity of neutralizing agent needed to neutralize the residual agricultural product. The sprayer is then operated to flush the cleaning agent through the sprayer system to remove the residual agricultural product or neutralize the residual agricultural product forming a rinsate. In an example, the rinsate is flushed through the spray nozzles to clean the nozzles. The rinsate is collected for disposal. After flushing of the rinsate the sprayer, in one example, is clean and ready for loading with another agricultural product. However, as noted herein residual agricultural product remains in some examples, for instance with inaccurate administration of a quantity of cleaning agent, incomplete neutralization, accumulation of residue or the like.

The cleaning process is laborious and time consuming After a spraying operation the agricultural sprayer is driven from the field to a reclamation site for evacuation of the remaining agricultural product, the operator then administers cleaning agents (e.g., based on a best guess) and conducts a flushing operation to minimize the presence of agricultural product residue. It is difficult to ascertain whether the agricultural product residue is in fact removed or neutralized in a manner that minimizes unintended dispensing of residue through spray nozzles and reactions with a different agricultural product administered to the agricultural sprayer.

After the cleaning process (e.g., at a reclamation site) the agricultural sprayer is prepared, now or at a time in the future, for another use. For example, the agricultural sprayer is filled with a new (different) agricultural product and driven to a field to apply the new agricultural product. Because of the difficulty in determining whether the previous residual product is cleaned (e.g., removed or neutralized) it is unclear to the operator if the new agricultural product will have diminished efficacy or an unintended reaction.

The present subject matter provides a solution to these problems with an agricultural cleaning assembly configured to thoroughly clean one or more of the boom tubes and the associated spray nozzles or the agricultural product reservoir (e.g., a reservoir having a premixed agricultural product, an injection reservoir, carrier reservoir or the like). The agricultural cleaning assembly includes a cleaning agent reservoir having a cleaning agent therein (e.g., a neutralizing agent; solution, such as detergent or soap; diluting liquid; or the like).

The agricultural cleaning assembly further includes a cleaning control system having a cleaning actuator configured to control administration of the cleaning agent to the agricultural sprayer plumbing, for instance through one or more system interfaces that interconnect the assembly to the agricultural sprayer plumbing. In one example, the cleaning control system includes one or more constituent sensors configured to monitor constituent characteristics of rinsate (e.g., residual agricultural product mixed with cleaning agent, intermediates of the same or the like) in the agricultural sprayer plumbing. The constituent sensors monitor one or more of composition, concentration or the like of constituents of the agricultural product and rinsate (including the agricultural product and cleaning agent), such as injection products, cleaning agents or the like. A cleaning controller in communication with the one or more constituent sensors assesses the constituent characteristics and controls the cleaning configuration of the agricultural sprayer plumbing. For example, the cleaning controller is in communication with the cleaning actuator (e.g., control valve, pump or the like), and the cleaning actuator controls the administration of cleaning agent to the agricultural sprayer plumbing according to instructions from the cleaning controller.

In one example, cleaning agent is administered (e.g., circulated in the plumbing) and constituent characteristics are monitored (e.g., neutralization, dilution, presence or lack thereof of additives or residue or the like) to assess completion of cleaning in a cleaning configuration. For example, when the one or more constituent characteristics of rinsate (cleaning agent and agricultural product) fall below or meet constituent thresholds cleaning agent administration is arrested. In another example, a quantity of cleaning agent is administered and constituent characteristics of the rinsate are monitored to prompt supplemental administration of the cleaning agent when one or more constituent characteristics fail to meet constituent thresholds, for instance in the manner of feedback control. In various examples, the one or more monitored constituent characteristics are compared against constituent thresholds to ensure cleaning efficacy and minimize retention of residual agricultural product or cleaning agents in the agricultural sprayer plumbing that may interact with or decrease the efficacy of future agricultural products in the agricultural sprayer plumbing. In still other examples, the cleaning controller conducts iterative cleaning, such as first and second cleaning procedures (or more) with or without constituent sensors while using other thresholds such as cleaning procedure counts, durations, circulation timing or counts (recirculation) or the like.

In another example, the cleaning controller controls evacuation of rinsate from the agricultural sprayer plumbing. For instance, after the cleaning configuration is completed (e.g., constituent characteristics meet constituent thresholds, iterative cleaning is completed, or the like) the cleaning controller operates a rinsate actuator and conveys the rinsate to a rinsate reservoir. The rinsate reservoir, in an example, is a reservoir on the agricultural sprayer designated for reception of rinsate. In another example, the rinsate reservoir includes the agricultural product reservoir (or carrier fluid reservoir) after the spraying operation is completed and the reservoir is empty or sufficiently empty to receive the rinsate.

Optionally, the cleaning controller controls evacuation of rinsate from the agricultural sprayer plumbing with an air actuator. The air actuator includes one or more of an air compressor, control valve or the like that is controlled to administer pressurized gas to the agricultural sprayer plumbing. The air actuator flushes the rinsate from the plumbing, for instance through the spray nozzles of the boom tubes. In another example, the air actuator flushes the rinsate into one or more vented rinsate reservoirs.

The agricultural cleaning assembly described herein is, in one example, an onboard system included with an agricultural sprayer. In another example, the agricultural cleaning assembly is included with a nurse vehicle configured to approach an agricultural sprayer, interconnect with the agricultural sprayer plumbing, and conduct cleaning operations. For instance, the nurse vehicle includes a cleaning agent reservoir, the cleaning controller, a rinsate reservoir and a system interface for fluid communication with the agricultural sprayer plumbing. The cleaning operations are conducted on site and thereby minimize driving of the sprayer to a location for evacuation and cleaning, instead cleaning is conducted in or adjacent to the field in an example. Optionally, the nurse vehicle includes one or more reservoirs for carrier fluid, injection products, premixed agricultural products or the like. In this example, the nurse vehicle conducts on site cleaning operations as well as on site filling of the agricultural sprayer with agricultural products (or carrier fluid and injection products) to facilitate immediate conducting of additional agricultural operations by the agricultural sprayer.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of an agricultural sprayer.

FIG. 2 is a schematic view of one example of a spraying system having an agricultural sprayer cleaning assembly.

FIG. 3 is a schematic view of the spraying system of FIG. 2 in an application configuration for applying an agricultural product.

FIG. 4A is a schematic view of the spraying system of FIG. 2 in a first example of a cleaning configuration with the agricultural sprayer cleaning assembly.

FIG. 4B is a schematic view of the spraying system of FIG. 2 in another example of a cleaning configuration with the agricultural sprayer cleaning assembly.

FIG. 5 is a schematic view of the spraying system of FIG. 2 in an additional example of a cleaning configuration including consolidated cleaning agent and rinsate reservoirs.

FIG. 6 is a schematic view of the spraying system of FIG. 2 in another example of a cleaning configuration including air evacuation.

FIG. 7 is a schematic view of one example of a cleaning control system.

FIG. 8 is a schematic view of one example of an agricultural sprayer cleaning assembly configured for installation with one or more of an agricultural sprayer or nurse truck.

FIG. 9 is a block diagram illustrating one example of a method for cleaning an agricultural sprayer.

### DETAILED DESCRIPTION

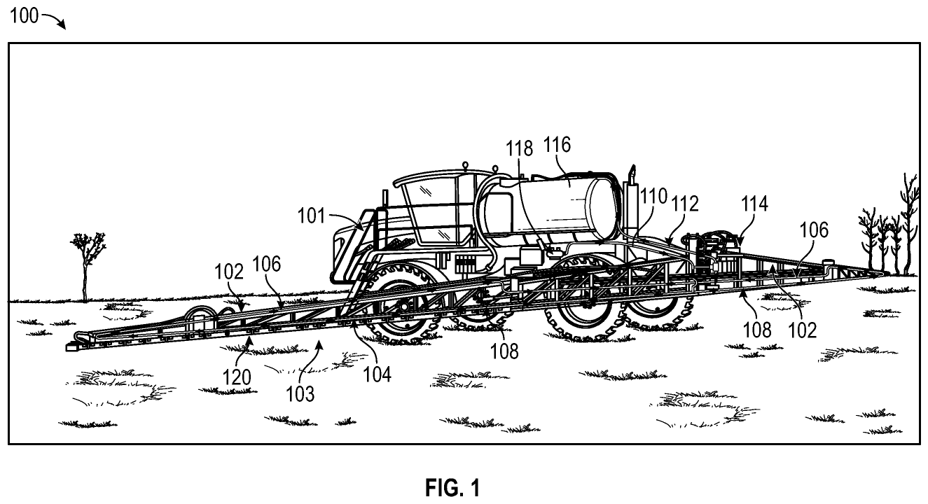

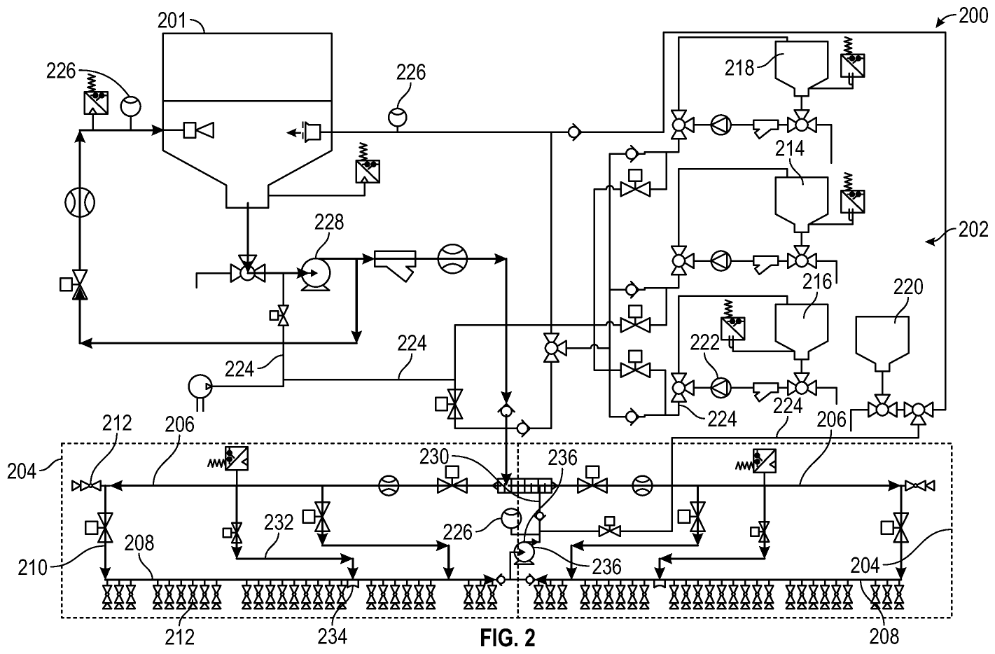

FIG. 1 is a perspective view of one example of agricultural sprayer 100. The sprayer 100 includes a chassis 101 that carries a supply tank 116 of an agricultural solution including a carrier fluid and mixed agricultural product including, but not limited to, fertilizers, herbicides, pesticides or the like. Optionally, the supply tank 116 stores the carrier fluid, such as water, and a separate agricultural product reservoir (see FIG. 2) provides the agricultural product for metered administration to the carrier fluid prior to delivery to the sprayer booms 102.

The agricultural sprayer 100 includes a spraying system extending from the supply tank 116 to one or more product dispensers 120 along sprayer booms 102. The sprayer booms 102 extend from the chassis 101 and each include respective sprayer boom tubes 104. As shown in the schematic illustration overlaying the sprayer 100 the supply tank 116 includes a main line 110 and a system pump 118 along the main line 110. The main line 110 is in communication with the sprayer boom tubes 104. Operation of the system pump 118 delivers the mixed agricultural solution to the sprayer boom tubes for delivery through one or more product dispensers 120. The product dispensers 120 include, but are not limited to, one or more nozzles, arrays of nozzles, boom sections or the like. As further shown in FIG. 1, the sprayer boom tubes 104 include proximal and distal portions 106, 108. For example, the proximal portions 106 extend along the sprayer booms 102 toward the respective ends of the booms 102 remote from the chassis 101. The distal portions 108 of the sprayer boom tubes 104 are in one example downstream from the respective proximal portions 106 and extend from the ends of the booms 102 toward the chassis 101. In this example, the product dispensers 120 are provided along the distal portions 108.

A control valve 114 (e.g., a three-way control valve or the like) is interposed between the main line 110 and the sprayer boom tubes 104, and the main line 110 line is configured to deliver the pumped agricultural product from the supply tank 116 to at least one of the sprayer boom tubes 104 (e.g., the proximal portion 106 of the right boom tube 104). In the application configuration the supply tank 116 (and optionally one or more additive or injection reservoirs) are in communication with the sprayer boom tubes 104 and the product dispensers 120 thereon to permit the sprayed application of agricultural products. In the view shown in FIG. 1, the main line 110 is in communication with the sprayer boom tubes 104 (e.g., first, second, right, left, center or the like). The agricultural product is delivered from the supply tank 116 by the system pump 118 to each of the sprayer boom tubes 104 by way of the main line 110 and, in this example, the control valve 114. The proximal portions 106 of the sprayer boom tubes 104 deliver the agricultural solution to the ends of the sprayer booms 102, and the agricultural solution optionally returns along the distal portions 108 of the sprayer boom tubes 104 for dispensing from the one or more product dispensers 120.

In some examples, described herein, circulation of fluids other than agricultural products through the sprayer system 103 is specified. For instance, cleaning agents are circulated through the sprayer system 103 to remove residue of a first agricultural product and prepare the system 103 for a second agricultural product. Where cleaning is specified the sprayer system 103 is reconfigured to a cleaning configuration relative to the application configuration.

FIG. 2 is a schematic view of an example spraying system 200, for instance as the implement of an agricultural sprayer. The spraying system 200 includes a carrier fluid reservoir 201. In an example, the carrier fluid reservoir 201 is an example of agricultural product reservoir configured to contain an agricultural product for application by the spraying system 200. In another example, the carrier fluid reservoir 201 includes a base fluid, such as water, a premixed agricultural product or the like. Optionally, the spraying system 200 includes one or more injection product reservoirs 214 configured to provide a separate source of an agricultural product for mixing with the carrier fluid, for instance prior to application.

Referring again to FIG. 2, a carrier fluid pump 228 (an example system pump) is downstream from the carrier fluid reservoir 201. The carrier fluid pump 228 delivers carrier fluid (including a premixed agricultural product) from the reservoir 201 to the sprayer booms 204. In the example shown the each of the sprayer booms 204 includes boom tube proximal portion 206 and boom tube distal portions 208. An example flow diagram is shown with arrows. In the example, flow of the carrier fluid is provided to each of the boom tube proximal portions 206 and then passes to the boom tube distal portions 208. In the example shown, the boom tube distal portions 208 include product dispensers such as spray nozzles 212.

Optionally, the boom tube proximal and distal portions 206, 208 are interconnected with a recirculation bridge 230. The recirculation bridge permits the recirculation of the carrier fluid (including an agricultural product) within the sprayer booms 204 to minimize stagnation, settling or the like. Optionally, the sprayer booms 204 include one or more capillary bridges 232 that interconnect the proximal and distal portions 206, 208 to permit shunting or shortcuts between the portions. In one example, the capillary bridges 232 facilitate mixing and achieving concentrations, constituencies or the like of the agricultural product in a rapid manner in comparison to linear flow from the proximal to the distal portions 206, 208 (e.g., along the full lengths of the portions 206, 208). In another example, one or more venturis 234 are included that provide constrain flow through a segment of the distal portions 208, thereby accelerate fluid velocity, and generate a pressure decrease that draws fluid through the capillary bridges preferentially from the proximal portions 206 to the associated distal portions 208 (e.g., across from each other at the bridges 232). As further described herein, the recirculation bridge 230, capillary bridge 232, venturis 234 or the like facilitate interchange of fluid between the boom tube proximal and distal portions 206, 208.

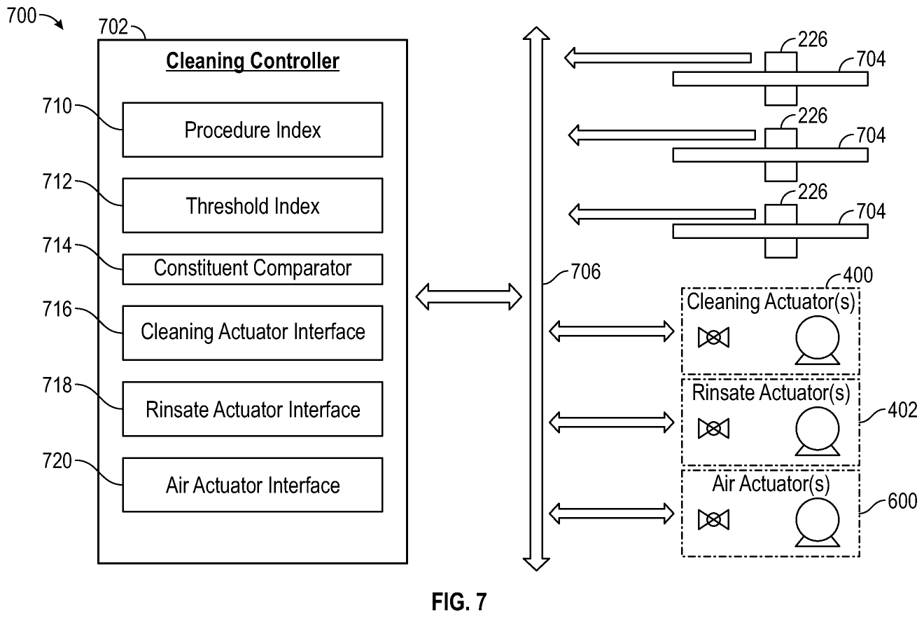

Referring again to FIG. 2, the sprayer system 200 further includes an agricultural sprayer cleaning assembly 202. The cleaning assembly 202 is an interconnected system with the sprayer system 200 that permits the cleaning of the sprayer system 200. The agricultural sprayer cleaning assembly 202 includes a cleaning agent reservoir 216 having one or more cleaning agents contained therein (e.g., neutralizing agents, dilution fluids, water or the like). The cleaning agent reservoir 216 is interconnected with the sprayer system 200 at a system interface 224, such as a valve, port, pump, tube or the like. In the example shown in FIG. 2, a cleaning agent pump 222 is in communication with the reservoir 216 and configured to deliver the cleaning agent to the sprayer system 200, for instance based on instructions and control implemented with the cleaning controller 702 (shown in FIG. 7).

In another example, the cleaning assembly 202 includes a dilution reservoir 218. The dilution reservoir 218 is an example of a cleaning agent reservoir. In a similar manner to the cleaning agent reservoir 216, a pump, valve or the like is provided with the dilution reservoir 218 to selectively interconnect the reservoir 218 to the sprayer system 200 for administering of a cleaning agent. The dilution reservoir 218 contains one or more fluids for cleaning of the sprayer system 200. In one example, the dilution reservoir 218 contains a cleaning agent like the cleaning agent reservoir 216. Optionally, the cleaning agent has different constituents, concentrations or the like of additives. In another example, the dilution reservoir 218 includes a dilution fluid, such as water, as the cleaning agent. Administering the dilution fluid dilutes the agricultural product in the sprayer system 200.

As shown in FIG. 2, the agricultural sprayer cleaning assembly 202 includes one or more system interfaces 224 between the components of the assembly 202 and the remainder of the sprayer system 200. The system interfaces 224 include, but are not limited to, valves, three or four way valves, pumps, interconnecting tubing or the like that permit the selective interconnection and isolation of the cleaning assembly 202 to the sprayer system 200. As described herein, the sprayer system 200 includes an application configuration (shown in FIG. 2) for the application of agricultural products through the spray nozzles 212. Additionally, the sprayer system 200 includes one or more cleaning configurations that interconnect the system 200 with the agricultural sprayer cleaning assembly 202 to permit cleaning of the system 200. The system interfaces 224 permit the interconnections. Optionally, the system interfaces 224 isolate portions of the sprayer system 200 from other portions of the system to permit the selective cleaning of the portions. For instance, in a first cleaning configuration the carrier fluid reservoir 201 and its associated plumbing, pumps, valves or the like are isolated from the cleaning assembly 202 and the sprayer booms while the sprayer booms 204 are cleaned. In a second cleaning configuration the sprayer booms 204 are isolated from the carrier fluid reservoir 201 and the cleaning assembly 202, and the cleaning assembly 202 accordingly cleans the carrier fluid reservoir 201 and its associated plumbing.

As further shown in FIG. 2, the agricultural sprayer cleaning assembly 202 optionally includes a rinsate reservoir 220 that receives and stores residual agricultural product, cleaning agents, intermediates of the treated (e.g., neutralized) agricultural product or the like. The rinsate reservoir 220 is interconnected with portions of the clayer system 200. As shown in the example in FIG. 2, the rinsate reservoir 220 is in communication with one or more of the carrier fluid reservoir 201 and its associated plumbing and the one or more sprayer booms 204. Optionally, a system interface, such as a valve, three way valve, four way valve or the like is provided proximate to the rinsate reservoir 220 to permit its selective interconnection with components of the cleaning assembly 202 and the sprayer system 200.

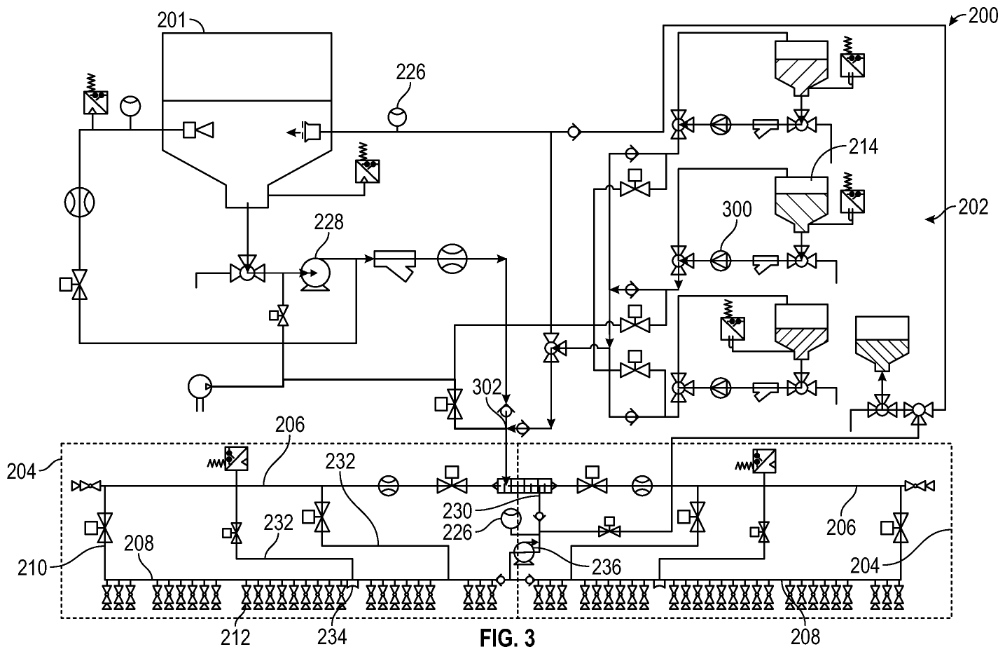

In another example, the cleaning assembly 202 includes one or more constituent sensors 226. As shown in FIG. 2 the constituent sensors 226 are coupled along portions of the sprayer system 200, the cleaning assembly 202 or both. The constituent sensors 226 include one or more chemical sensors that identify one or more of chemicals, concentrations of chemicals or the like within fluids. Examples of constituent sensors 226 include, but are not limited to, electronic (e.g., semiconductor based), optical, acoustic, wave, electrochemical and potentiometric sensors. As described herein, the constituent sensors 226 permit the monitoring of fluids within the sprayer system 200 and the cleaning assembly 202. In examples of the cleaning assembly 202 including a cleaning controller 702 (FIG. 7) the constituent sensors 226 are interconnected with the controller 702 to permit feedback based control of the cleaning assembly 202, for instance through controlled conduct of cleaning procedures, administration of cleaning agents, collection of rinsate, flushing of the system 200 or the like. In other examples the constituent sensors 226 permit monitoring of the agricultural product with regard to additives (e.g., fertilizer, herbicide or the like) constituency and concentration. The constituent sensors 226 are in communication with an injection controller that controls an injection pump 300 (see FIG. 3) to modulate the injection of injection product additives to the agricultural fluid, for instance at the junction 302 (FIG. 3) or along the sprayer booms 204 (e.g., proximate to the spray nozzles 212).

FIG. 3 illustrates another configuration of the sprayer system 200 having the agricultural sprayer cleaning assembly 202. In this example, the sprayer system 200 is in an injection configuration. The optional injectin product reservoir 214 is included and provides an injection product additive, such as a concentrated fertilizer, herbicide, pesticide or the like to the carrier fluid, for instance at a juncture 302 between the carrier fluid reservoir 202 and the spray nozzles 212.

An injection pump 300 is interposed between the injection product reservoir 214 and the juncture 302. In one example, the injection pump 300 is a metering pump, pulse width modulated pump or the like configured to provide a specified quantity (e.g., flow rate, variable flow rate or the like) of the additive to the carrier fluid. The specified quantity of the additive mixes with the carrier fluid to provide an agricultural product having one or more of a corresponding specified constituency or concentration of the additive.

As previously described, the constituent sensors 226 in some examples monitor the characteristics of the agricultural product including one or more of the constituency or concentration of additives in the product. Optionally, one or more constituent sensors 226 (e.g., along the sprayer boom 204 plumbing) are in communication with a sprayer system 200 controller, and the controller is in communicating with the injection pump 300. The sprayer system 200 controller accordingly conducts feedback control of the agricultural product through monitoring of the constituency of the product (with the sensors 226) and determining differences between threshold values for constituency (composition), concentration or the like, and operates the injection pump 300 to meter additives to address the determined difference.

Mixing of the injection product additives (as well as cleaning agents) is in some examples facilitated with one or more of the capillary bridges 232, venturis 234, the recirculation bridge 230 or the like. As previously discussed, these features permit one or more of shunting or recirculation of injection product additives, cleaning agents, and rinsate or the like across the boom tube proximal and distal portions 206, 208 to accelerate mixing of the additives with the carrier fluid, agricultural product or the like. For instance, the Additionally, recirculation with the recirculation bridge 230 enhances mixing and decreases stagnation, settingling or the of the agricultural product.

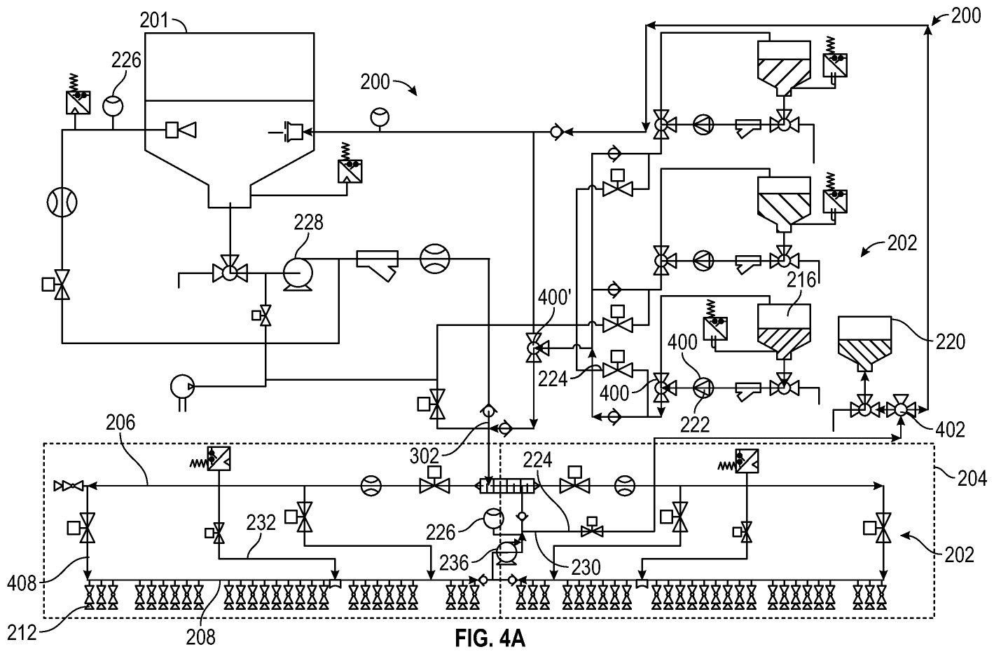

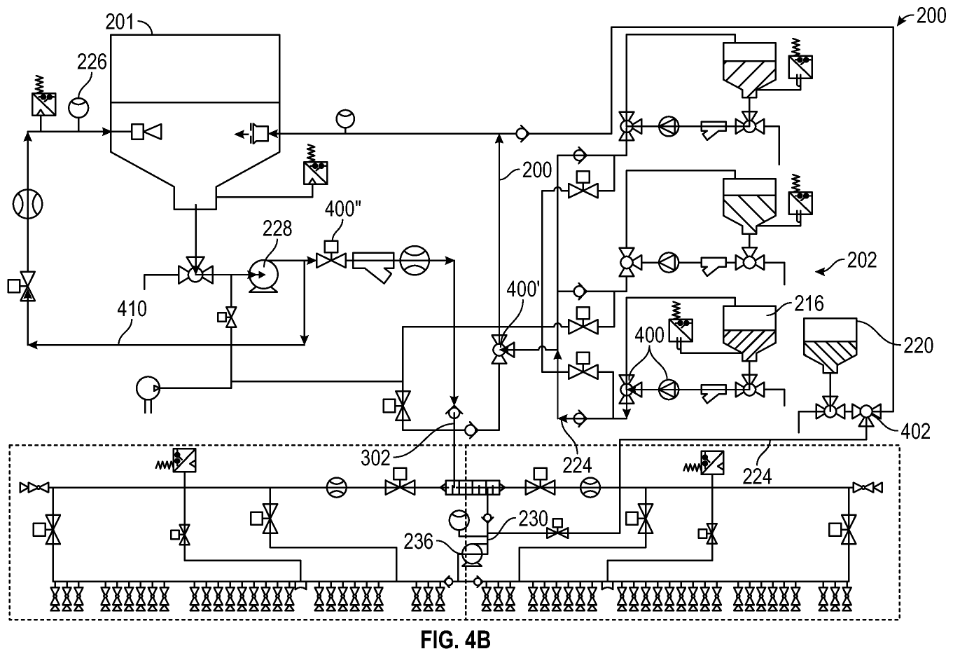

FIG. 4A is a schematic view of the spraying system 200 in a first example of a cleaning configuration with the agricultural sprayer cleaning assembly 202. In this example, a cleaning agent (e.g., water, neutralizing agent or the like) is administered from the cleaning agent reservoir 216, dilution reservoir 218 (example of a cleaning agent reservoir) or the like to one or more of the sprayer booms 204, spray nozzles 212, carrier fluid reservoir 201 or the like including the associated plumbing.

As shown with arrows extending from the cleaning agent reservoir 216 cleaning agent is administered from the cleaning agent reservoir 216 to the boom tubes 206, 208 and the associated spray nozzles 212, for instance with the cleaning agent pump 222. The cleaning agent pump 222 delivers the cleaning agent to the juncture 302. The cleaning agent pump 222 and the control valve downstream of the cleaning agent pump 222 and upstream from the juncture 302 are examples of cleaning actuators 400 configured to control the flow of the cleaning agent from the agricultural sprayer cleaning assembly 202 to the remainder of the sprayer system 200.

The associated plumbing, valves or the like extending from the cleaning agent reservoir 216 to the sprayer sprayer 200 are examples of system interfaces 224 (see FIG. 2) that interconnect the agricultural sprayer cleaning assembly 202 with the sprayer system 200. Accordingly, the cleaning assembly 202 is in one example a component of the sprayer system 200, and is configured to selectively communicate with the sprayer system 200 to conduct cleaning of the sprayer system 200 and preparation of the system for conduct of another agricultural operation.

In operation in the example cleaning configuration shown in FIG. 4A, the cleaning agent enters the remainder of the sprayer system 200 in a controlled manner according to one or more of the cleaning actuators 400. In this example, the cleaning agent enters at the juncture 302 and mixes with the agricultural product, such as residue agricultural product, in the sprayer booms 204. In this example, the sprayer booms 204 include proximal and distal portions 206, 208. The cleaning agent administered to the sprayer booms 204 circulates through the sprayer booms 204. For example, the cleaning agent is circulated through the proximal and distal portions 206, 208 of the sprayer booms 204. An example agitation circuit 408 is shown in FIG. 4A with arrows that represent circulation (and recirculation) of the fluids through the sprayer booms 204. Direction of the fluids along the agitation circuit 408 with the cleaning assembly 202 mixes the cleaning agent with the agricultural product residue, directs cleaning agent into difficult to access elbows, valves or the like (in some examples repeatedly) and accordingly enhances the effectiveness of the cleaning agent.

In one example the cleaning agent pump 222 provides the pressure for circulation. In another example, the carrier fluid pump 228 provides pressure for circulation. The cleaning agent pump 222 operates at a higher pressure than the carrier fluid pump 228 to ensure administering of the cleaning agent to the sprayer system 200. Optionally, the cleaning agent pump 222 and carrier fluid pump 228 work cooperatively to administer and circulate the cleaning agent with the agricultural product (or its residue).

Dwell time, circulation, agitation of the cleaning agent and agricultural product or the like are controlled in various examples with the cleaning controller 702 shown in FIG. 7. For instance, the cleaning controller 702 controls components of the sprayer system 200, the cleaning assembly 202 or the like to conduct one or more of cleaning procedures, feedback based control according to monitoring with the constituent sensors 206 or the like. The cleaning agent cleans the system of residual agricultural product, for instance through dilution, neutralization or the like. In another example, the cleaning agent is recirculated to enhance cleaning, for instance with the recirculation bridge 230 and recirculation pump 236, to cyclically, reversibly agitate the cleaning agent within the system 200. As shown in FIG. 4A, the cleaning agent is directed in an agitation circuit 408 to circulate the cleaning agent through the sprayer booms and enhance cleaning effectiveness.

The mixed cleaning agent and agricultural product residue, such as a neutralized agricultural product, are referred to as rinsate. In one example, the agricultural sprayer cleaning assembly 202 controls flow of rinsate as a component of the cleaning configuration. For example, the sprayer nozzles 212 are modulated open (e.g., with the cleaning controller 702) to permit flushing of the rinsate from the sprayer booms 204 and also clean out the sprayer nozzles 212.

As shown in FIG. 4A, the cleaning assembly 202 optionally includes a rinsate reservoir 220 and associated rinsate actuator 402. The cleaning assembly 202, such as the cleaning controller 702, coordinates the control of various actuators, for instance associated with control valves, to direct rinsate from the sprayer booms 204 to the rinsate reservoir 220. For example, after conduct of a cleaning procedure including, but not limited to, a timed procedure, specified circulation (including recirculation), feedback control or the like the cleaning controller 702 instructs the rinsate actuator 402 (e.g., a valve) to open. The rinsate in the sprayer booms 204 is delivered under pressure to the rinsate reservoir 220 and retained therein. In an example, water is pumped from one or more of the dilution reservoir 218, the carrier fluid reservoir 201 to pressurize the rinsate for delivery to the rinsate reservoir 220. In another example, the cleaning assembly 202 includes a compressed gas source that administers a compressed gas to flush the rinsate from the sprayer booms 204 into the rinsate reservoir 220.

FIG. 4B shows another example of a cleaning configuration for the cleaning assembly 202. In this example, the cleaning assembly 202 is transitioned to a different configuration from that shown in FIG. 4A. For instance, the cleaning agent from the cleaning agent reservoir 216 is directed to the agricultural product reservoir 201 (also referred to as a carrier fluid reservoir) to clean the reservoir 201 of residual agricultural product and the associated plumbing. A control valve as an example cleaning actuator 400′ is provided downstream from the cleaning agent reservoir 216 and upstream from the juncture 302. The control valve in this example includes a three-way valve that diverts flow of the cleaning agent from the sprayer booms 204 toward the carrier fluid reservoir 201.

The cleaning agent flow is shown with arrows in FIG. 4B. In this example, the cleaning agent is directed upwardly (relative to the page), and then is directed into carrier fluid reservoir 201 through a side port. The cleaning agent received in the reservoir 201 mixes with the residual agricultural product to treat the agricultural product for eventual disposal. The cleaning assembly 202 optionally circulates the cleaning agent through the reservoir 201 and the associated plumbing. For instance, the cleaning agent, along with residual agricultural product, is pumped from the cleaning agent reservoir 201 with the carrier fluid pump 228. A cleaning actuator 400″, such as a control valve, is actuated closed by the cleaning assembly 202 (e.g., the cleaning controller 702) to close the downstream flow of the cleaning agent otherwise caused with the carrier fluid pump 228. Instead, the cleaning agent is circulated with another example of an agitation circuit 410 that returns the cleaning agent and residual agricultural product to the carrier fluid reservoir 201. In an example, the cleaning agent is dispersed in the carrier fluid reservoir 201 with a distributor such as a spray nozzle, pickle barrel or the like to wash the cleaning agent through carrier fluid reservoir. Optionally, circulation continues (e.g., recirculation) based on the prescription conducted by the cleaning assembly 202 cleaning controller 702. For instance, the constituent sensor 226 shown in FIG. 4B proximate to the reservoir 201 monitors the composition, concentration or the like of the rinsate of the cleaning agent and residual agricultural product and the controller 702 administers additional cleaning agent, continues circulation or the like until a threshold is observed with the sensor 226.

In another example, the cleaning assembly 202 directs the rinsate proximate to the carrier fluid reservoir 201 for flushing or storage in the rinsate reservoir 220. The cleaning controller 702 actuates the valve shown as the cleaning actuator 400″ in FIG. 4B. The carrier fluid pump 228 is operated and directs the rinsate toward the sprayer boom 204. The rinsate is deliver to sprayer boom 204 and, in a similar manner to flushing in FIG. 4A, is flushed through the spray nozzles 212. Optionally, the rinsate is instead delivered from the recirculation bridge 230, for instance with the recirculation pump 236, toward the rinsate reservoir 220. The rinsate is received and stored in the rinsate reservoir 220 until evacuated, for instance at a reclamation site.

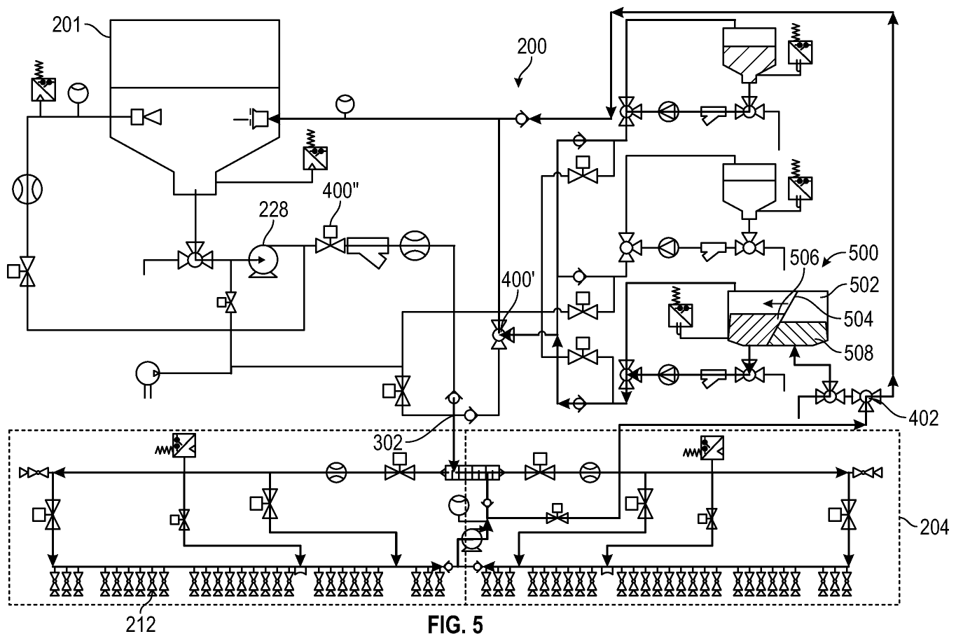

FIG. 5 is a schematic view of the sprayer system 200 with another example of an agricultural sprayer cleaning assembly 500. In the example the cleaning assembly 500 includes a cleaning agent and rinsate reservoir 502 that works with the other components of the cleaning assembly 500 to provide a source of the cleaning agent and a reservoir for retention of rinsate.

The cleaning agent and rinsate reservoir 502 in one example includes a septum 504 that isolates portions of the reservoir 502 from each other. For instance, a left portion of the reservoir 502 holds a volume of cleaning agent 506. The right portion of the reservoir 502 is configured to hold a separated volume of collected rinsate 508 (e.g., from one or more cleaning procedures). The septum 504 includes a diaphragm, bladder, pliable membrane, movable divider or the like that separates the cleaning agent from rinsate. In some examples, the cleaning agent and rinsate reservoir 502 initially is filled with cleaning agent. For instance, the portion of the reservoir 502 devoted to rinsate 508 is initially empty. Instead, the majority (including all) of the reservoir volume 502 is initially filled with cleaning agent 506. As the cleaning agent 506 is administered the portion of the reservoir 502 devoted to cleaning agent optionally shrinks. For instance, rinsate 508 received in the other portion of the reservoir 502 fills that portion, biases the septum 504, and accordingly the volume of the portion for the cleaning agent 506 decreases. The cleaning agent and rinsate reservoir 502 thereby transitions from containing cleaning reagent 506 to receiving and retaining rinsate 508.

The remainder of FIG. 5 illustrates the agricultural sprayer cleaning assembly 500 interfaced with the sprayer system 200. The assembly 500 includes similar components to the previously described example cleaning assembly 200. One example of a cleaning configuration is shown with arrows extending from the cleaning agent and rinsate reservoir 502 to provide cleaning agent to the sprayer booms 204. As shown, the cleaning agent 506 is circulated through the sprayer booms 204 to clean the sprayer booms 204. For instance, agricultural product, residue or the like is cleaned (e.g., diluted, carried, neutralized or the like) from the sprayer booms 204. Optionally, the rinsate 508 from cleaning is flushed from the sprayer nozzles 212. In another example, cleaning agent 506 is directed to the carrier fluid reservoir 201 for instance with the cleaning actuator 400′ shown in FIG. 5 to accordingly clean the reservoir 201 and the associated plumbing.

In another example, the cleaning assembly 500, such as a cleaning controller 702, modulates one or more actuators to selectively open plumbing to the rinsate receiving portion of the cleaning agent and rinsate reservoir 502. For example, a rinsate actuator 402 is opened to receive rinsate flow from the sprayer booms 204 (or carrier fluid reservoir 201) and direct the rinsate 508 into the rinsate portion of the reservoir 502. Because the cleaning agent 506 is administered from the cleaning portion of the reservoir 502 the septum 504 optionally moves and contracts the cleaning portion while rinsate 508 fills and expands the rinsate portion of the reservoir 502.

In another example, the rinsate actuator 402 is a three-way valve or the like and is controlled with the cleaning assembly 500 to direct rinsate 508 toward the carrier fluid reservoir 201 for storage prior to disposal (e.g., at a reclamation location). Optionally, if the cleaning agent and rinsate reservoir 502 is filled with rinsate 508 the carrier fluid reservoir 201 is a supplemental location for receipt of the rinsate 508. In other examples, one or more of the cleaning assemblies 202, 500 does not include a dedicated rinsate reservoir, and instead rinsate is retained in the carrier fluid reservoir 201.

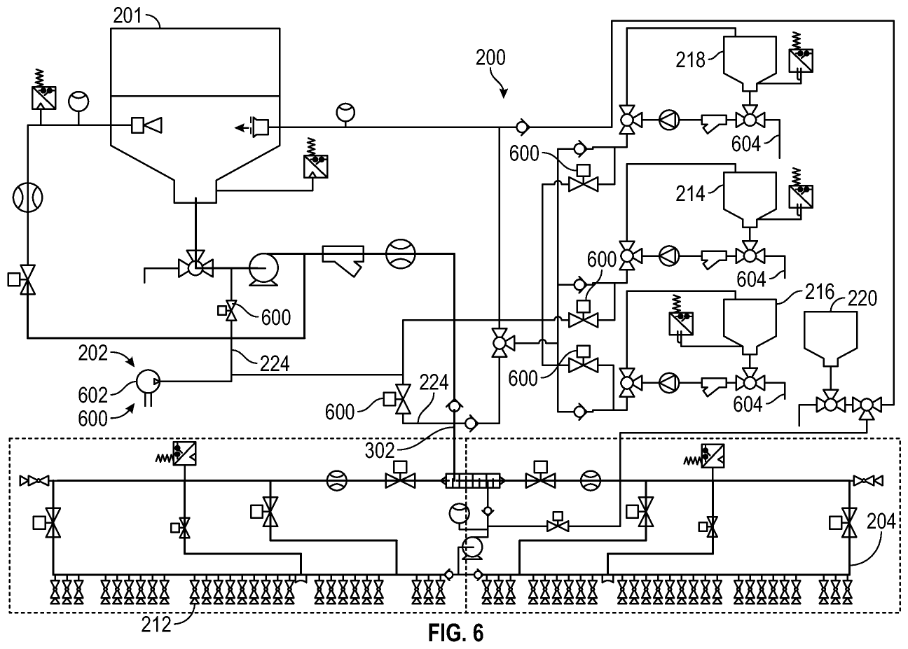

FIG. 6 is a schematic view of the sprayer system 200 having one example of a cleaning configuration including air evacuation. As described herein the agricultural cleaning assembly 202 (or 500) cleans the sprayer system 200. The cleaning procedures produce rinsate, mixtures of cleaning agents (including dilution agents, such as water) and agricultural product residue, neutralized agricultural products or the like. In some examples rinsate is evacuated from the sprayer system 200 from the spray nozzles 212. In other examples rinsate is retained in one or more reservoirs such as a rinsate reservoir 220 or the carrier fluid reservoir 201. Flushing of rinsate through either or both of the nozzles 212 or into reservoirs 220, 201 is, in one example, accomplished with pressurized (compressed) gas.

FIG. 6 shows one example of a source of compressed air 602, such as a compressor, air pump, compressed air tank or the like. The source 602 is coupled with the sprayer system 200 with another example of system interfaces 224. In the example shown in FIG. 6, system interfaces 224 connect the source 602 with each of the sprayer booms 204, the carrier fluid reservoir 201 and optionally the reservoirs 214, 216, 218. As further shown in FIG. 6, one or more air actuators 600 (valves, the source 602, or the like) are coupled with the cleaning assembly 202 and sprayer system 200 to permit selective administration of compressed gas to the sprayer system 200 to flush rinsate from the system.

In operation, after administration of a cleaning agent (e.g., cleaning fluids, dilution fluids or the like) and conduct of a cleaning procedure the cleaning controller 702 modulates one or more of the air actuators 600 to permit communication between the source of compressed air 602 and the sprayer system 200 having rinsate therein. In one example, the air actuator 600 proximate to the sprayer booms 204 is opened. The cleaning controller 702 operates the source of compressed air 602, such as a compressor, valve on a compressed air tank or the like, to administer compressed air to the sprayer booms 204, for instance through the juncture 302. The compressed air flushes the rinsate from the sprayer booms 204. In a first example, the spray nozzles 212 are opened to permit flushing of cleaning agent, rinsate or the like through the nozzles. The flushing cleans the nozzles of residue, stagnant cleaning agent or the like. In a second example, the spray nozzles 212 are closed and the compressed air flushes the rinsate out of the sprayer booms 204 and into a rinsate reservoir, such as the rinsate reservoir 220, carrier fluid reservoir 201, rinsate portion of the reservoir 502 (see FIG. 5) or the like.

In another example, air actuator 600 proximate to the carrier fluid reservoir 201 is opened, for instance by the cleaning controller 702 as part of a cleaning procedure including flushing, to permit the flow of compressed air to the reservoir 201 and its associated plumbing. The carrier fluid reservoir 201 includes a drain, and the compressed air flushes the rinsate through the drain, for instance at a reclamation location.

In still another example, air actuators 600 associated with the injection product reservoir 214, cleaning agent reservoir 216, dilution reservoir 218 or the like are opened (e.g., according to direction from cleaning controller 702). Compressed air is delivered to one or more of the reservoirs 214, 216, 218 and the reservoirs are flushed. As shown in FIG. 6, the reservoirs include drains 604 and rinsate, cleaning agent, injection product, dilution fluid are the like are flushed through the drains.

Optionally, the constituent sensors 226, previously described herein, monitor flushing of the associated plumbing. In one example, the cleaning controller 702 conducts flushing of the sprayer system 200 until a threshold evacuation is reached such as the failure to observe one or more constituents above a threshold value representative of liquid presence in the plumbing. In another example, the cleaning controller conducts flushing of the sprayer system 200 for a specified period, such as 15 seconds, 30 seconds, 1 minute or the like.

FIG. 7 is a schematic view of one example of a cleaning control system 700. The cleaning control system 700 is a component of the agricultural sprayer cleaning assembly examples 202, 500 described herein. The cleaning control system 700 coordinates one or more sensors, actuators or the like with cleaning procedures to clean the sprayer system 200. As shown in FIG. 7, the cleaning control system 700 includes a cleaning controller 702, such as one or more processors, associated memory, computer readable media or the like, in communication with the one or more sensors and actuators. In the example shown in FIG. 7, the cleaning controller 702 is interconnected with sensors and actuators with an interface 706 such as a BUS, CAN BUS, wireless network, wiring or the like.

As further shown in FIG. 7, in one example the cleaning control system 700 includes one or more sensors. Examples of the one or more sensors include the constituent sensors 226 described herein. In FIG. 7, example constituent sensors 226 are coupled with plumbing 704 of the sprayer system 200 including, but not limited to tubing, valves, pumps, tanks or reservoirs or the like. The constituent sensors 226 monitor one or more constituent characteristics of fluids in the associated plumbing 704 including but not limited to, composition, concentration of those components or the like. In other examples, the constituent sensors include one or more of flow sensors (flow meters), pressure sensors or the like. The sensors in communication with the cleaning controller 702 permit monitoring of conditions in the associated plumbing 704 including, but not limited to, the sprayer booms 204, the carrier fluid reservoir 201 (also referred to as an agricultural product reservoir) and its associated plumbing, one or more of the reservoirs 214, 216, 218 (see FIG. 2) and their associated plumbing. In various examples the sensors including constituent sensors 226, flow meters, pressure sensors or the like permit open loop or feedback-based control of the agricultural sprayer cleaning assemblies 202, 500 described herein.

Referring again to FIG. 7, one or more actuators are included in the cleaning control system 700 and are in communication with the cleaning controller 702. Examples of the actuators include cleaning actuators 400, such as one or more of pumps, control valves, or the like that facilitate the opening and closing of the sprayer system 200 to receive and direct the flow of cleaning agents, such as cleaning agents from the cleaning agent reservoir 216 or the dilution reservoir 218 (e.g., such as water). Other example actuators include rinsate actuators 402, such as pumps, control valves, or the like that selectively open and close access to rinsate plumbing and the rinsate reservoir 220 to accordingly direct and receive rinsate for storage and eventual evacuation. Air actuators 600 are another example of actuators in communication with the cleaning controller 702. The air actuators 600 open and close the sprayer system 200 to a source of pressurized gas to permit flushing of the sprayer system 200 with the pressurized gas, such as compressed air.

In the example shown in FIG. 7, the cleaning controller includes a procedure index 710 having one or more prescribed cleaning procedures. The cleaning controller 702 implements these cleaning procedures to coordinate the operation of valves, pumps or the like (collectively, actuators) to open and close portions of the sprayer system 200, administer cleaning agents, fill rinsate tanks, administer compressed air for flushing or the like. The procedure index 710 further controls procedure counts, dwell times, circulation (including recirculation), agitation (including recirculation and reversible/oscillatory recirculation) as components of the procedures. The procedures implemented (and optionally stored with the index 710) in some examples vary based on agricultural product, cleaning agent, model of sprayer, next agricultural product (e.g., to minimize interaction between an existing product and the next product) or the like.

The cleaning procedures include one or more procedure characteristics or features, such as, but not limited to, procedure type, feedback control specifications, procedure counter, procedure timer, system volume, cleaning agent ate, cleaning agent application quantity, rinsate reservoir volume, dwell time, agitation or recirculation specifications or the like. The procedure index 710 provides the cleaning controller 702 with specifications for actuation and coordination of actuation of the various actuators (valves, pumps or the like) to control one or more of delivery of cleaning agent, dilution agent, flushing of rinsate, collection of rinsate or the like. In various examples, the procedure index 710 specifies sensors, such as constituent sensors 226, flow sensors, pressure sensors or the like, for monitoring the cleaning assembly 800 and optionally permitting feedback control.

A first example cleaning procedure includes administration of cleaning agent and circulation of the agent in the plumbing of the sprayer booms 204 for 3 minutes, dwell (waiting) 5 minutes with the agent in the booms, rinse the plumbing with a dilution agent such as water for 2 minutes, dwell 5 minutes with the dilution agent, and then rinse for 5 minutes. The resulting rinsate is collected in the rinsate reservoir 220, carrier fluid reservoir 201 (used as a rinsate reservoir) or the like. Optionally, the procedure is repeated for the carrier fluid reservoir 201 and its associated plumbing.

A second example cleaning procedure includes administration of cleaning agent for 3 mins in one or both of the sprayer booms or the carrier fluid reservoir 201, followed by rinsing with a dilution agent (such as water) for 1 min. The rinsate is then flushed from the system 200 through the spray nozzles 212, in one example with pressurized gas (compressed air) controlled with the air actuators 600. In another example, the rinsate is flushed into the rinsate reservoir 220 with pressurized gas.

Optionally, one or more of rinsing, dwelling or administration of cleaning agent includes circulation (including agitation, recirculation or the like) of the associated fluid (e.g., water, cleaning agent, rinsate). For instance, one or more cleaning actuators 400, such as pumps and valves, are actuated to circulate the fluid through the sprayer booms 204, carrier fluid reservoir 201 and plumbing or the like. In one example, the recirculation pump 236 is operated to circulate fluids in the sprayer booms 204. In another example, the carrier fluid pump 228 is operated to circulate fluids in and proximate to the carrier fluid reservoir 201.

In still other examples, the cleaning controller 702 includes a threshold index 712, constituent comparator 714 or the like to permit monitoring of fluids in the sprayer system 200 and conduct of cleaning procedures using feedback control. The threshold index includes one or more thresholds of an agricultural product (e.g., constituency, concentration or the like), cleaning agent, intermediates or the like. In one example, the constituent sensors 226 monitor one or more constituent characteristics of fluids in the plumbing 704. Constituent characteristics include, but are not limited to, composition, concentration or the like (optionally, flow rate, pressure or the like) of fluids in the sprayer booms 204 or other segments of the sprayer system. The monitored constituent characteristics are compared by the constituent comparator 714 with one or more associated thresholds provided with the threshold index 712. For instance, cleaning agent is administered as a bolus, at a specified flow rate or the like until a threshold of the agricultural product constituent characteristic is reached (e.g., 10 parts per million of an agricultural product fertilizer or less). In another example, circulation cycles; cycles of cleaning agent administration, dwell time, and rinsing are repeated until a constituent characteristic is measured that satisfies the associated threshold, thereby indicating a specified level of sprayer cleaning.

In another example, the monitored constituency characteristic is associated with the cleaning agent. For instance, the constituent comparator 714 administers cleaning agent to the sprayer system until a cleaning agent threshold is achieved (e.g., 1000 parts per million of the cleaning agent in a fluid within the sprayer booms 204). With cycles of rinsing or the like, including evacuation of rinsate and repetition of cleaning agent administration, the constituency sensors 226 and constituent comparator 714 continue working cooperatively. Accordingly, the cleaning controller 702 ensures the administration of cleaning agent in quantities to accurately conduct cleaning to achieve one or more cleaning thresholds that indicate the sprayer system 200 has sufficient cleaning agent to conduct cleaning of the system. Similar, the constituency sensors 226 monitoring characteristics of the rinsate, such as neutralization of the agricultural product, dilution of the product or the like permit the cleaning controller 702 to identify the sprayer system 200 is cleaned. In one example, the cleaning controller 702 then evacuates the rinsate (e.g., with compressed air) through the spray nozzles 212, a drain, or to a rinsate reservoir 220 (see FIG. 4A).

Referring again to FIG. 7, the cleaning controller 702 includes one or more interfaces interconnecting the controller 702 with actuators of the agricultural sprayer cleaning assemblies 202, 500. As shown, the controller 702 in this example includes a cleaning actuator interface 716, rinsate actuator interface 718, and an air actuator interface 720. The interfaces 716, 718, 720 communicate with the respective actuators 400, 402, 600 to provide instructions to the actuators based on procedures implemented by the cleaning controller 702. Instructions for opening, closing, and partial opening of valves, operation of pumps, compressors or the like are generated by the cleaning controller 702 and provided through the respective interfaces 716, 718, 720 to operate the actuators of the agricultural sprayer cleaning assemblies 202, 500.

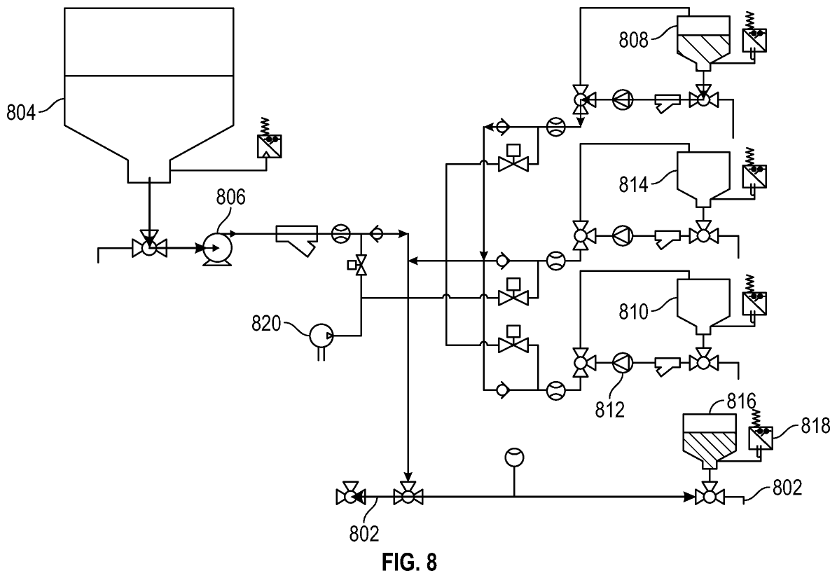

FIG. 8 is a schematic view of one example of an agricultural sprayer cleaning assembly 800 configured for installation with one or more of an agricultural sprayer or nurse truck. As shown, the cleaning assembly 800 is a separate component from an agricultural sprayer and is configured for coupling with the agricultural sprayer to conduct cleaning operations, evacuation of rinsate, and optionally onsite delivery of agricultural products for filling of the cleaned agricultural sprayer.

The agricultural sprayer cleaning assembly 800 is similar in some regards to the cleaning assemblies 202, 500 described herein. The cleaning assembly 800 includes a cleaning agent reservoir 810 and cleaning agent pump 812. The cleaning agent reservoir 810 and pump 812 (an example cleaning actuator) are coupled with a system interface 802 that selectively interconnects the assembly 800 with an agricultural sprayer. For example, a nurse truck having the cleaning assembly 800 is driven proximate to the agricultural sprayer, and the system interface 802 is interconnected with the plumbing of the agricultural sprayer with a flanged coupling, quick interconnect coupling, threated coupling or the like. The system interface 802 includes an actuator, such as a valve, to fluidly interconnect the cleaning assembly 800 with the agricultural sprayer plumbing and permit conduct of one or more cleaning procedures. In another example, the system interface 802 and the cleaning assembly 800 are provided onboard an agricultural sprayer, and the system interface 802 interconnects the cleaning agent reservoir 810 or the like to the agricultural sprayer plumbing.

The cleaning assembly 800 optionally includes a rinsate reservoir 816 configured to receive rinsate from the agricultural sprayer plumbing, for instance, after conduct of one or more cleaning procedures. The rinsate reservoir 816 is, in one example, a dedicated reservoir that receives rinsate including agricultural product residue, cleaning agent, neutralized agricultural product, diluted agricultural product, intermediates or the like. A control valve selectively permits delivery of rinsate to the rinsate reservoir 816. Optionally, a pressure relief valve is included with the rinsate reservoir 816 to relieve pressure as the rinsate reservoir is filled with rinsate.

In other examples, the agricultural sprayer cleaning assembly 800 includes a dilution reservoir 814 and associated plumbing for interconnection and delivery of a dilution agent, such as water, to an agricultural sprayer connected at the system interface 802. The dilution agent is supplied as a component of one or more cleaning procedures conducted with the cleaning assembly 800. The dilution reservoir 814 and its associated plumbing, such as actuators (e.g., pump, control valves or the like) are similar to the dilution reservoir 218 and its associated plumbing shown and described herein.

As further shown in FIG. 8, the agricultural sprayer cleaning assembly 800 includes in this example an injection product reservoir 808 and associated plumbing for interconnection and delivery of an injection product, such as a concentrated agricultural product (fertilizer, herbicide, pesticide or the like), to an agricultural sprayer connected at the system interface 802 to fill and prepare the sprayer for operation. The injection product reservoir 808 and its associated plumbing, such as actuators (e.g., pump, control valves or the like) are similar to the injection product reservoir 214 and its associated plumbing shown and described herein.

The injection product reservoir 808 permits the refilling of the sprayer injection product reservoir 214. In one example, the system interface 802 is directly coupled with the injection product reservoir 214 for filing of the reservoir 214. In another example, the system interface 802 is coupled with another portion of the agricultural sprayer, and the agricultural sprayer controls the actuation of control valves to direct the injection product form the cleaning assembly 800 injection product reservoir 808 to the sprayer injection product reservoir 214. In still another example, the cleaning assembly 800 includes a cleaning controller 702 (e.g., of the cleaning control system 700 in FIG. 7) and the cleaning controller 702 actuates one or more of control valves, pumps (collectively actuators) of the cleaning assembly 800 as well as the sprayer system 200 of the agricultural sprayer, by way of wired or wireless connection, to deliver the injection product to the injection product reservoir 214.

As further shown in FIG. 8, the agricultural sprayer cleaning assembly 800 includes a carrier fluid reservoir 804, in another example. In a similar manner to the injection product reservoir 808, the carrier fluid reservoir 804 permits the filling of an agricultural sprayer carrier fluid reservoir 201 (see FIG. 2) of an agricultural sprayer. For instance, a nurse truck having the cleaning assembly 800 is driven proximate to the sprayer or the sprayer is driven to the nurse truck, and the system interface 802 is coupled with the agricultural sprayer plumbing. Actuators, such as valves, a carrier fluid pump 808, or the like, are operated to convey the carrier fluid (e.g., water, agricultural product or the like) from the carrier fluid reservoir 804, through the system interface 802, and to the carrier fluid reservoir 201 of the sprayer system 200 of the agricultural sprayer. Optionally, the cleaning controller 702 actuates control valves, pumps (collectively actuators) of one or both of the cleaning assembly 800 and the sprayer system 200 to deliver the carrier fluid to the carrier fluid reservoir 201.

In another example, the agricultural sprayer cleaning assembly 800 includes a source of compressed gas, such as an air compressor 818. The air compressor 818 permits flushing of the sprayer system 200 with interconnection of the cleaning assembly 800 with the system 200 (e.g., at the system interface 802). For instance, one or more actuators (valves, pumps or the like) are selectively opened and closed to delivery compressed air into the sprayer system 200 for flushing. In one example, flushed rinsate or the like is directed through sprayer nozzles 212. In another example, flushed rinsate is directed through a return, such as plumbing connected with the rinsate reservoir 816 of the agricultural sprayer cleaning assembly 800. For instance, a separate system interface 802 interconnects the plumbing of the sprayer system 200 with the rinsate reservoir 816. Accordingly, compressed air is conveyed through a first system interface 802, and flushed rinsate is received and stored at the rinsate reservoir 816 through a second system interface 802. In one example the vertical plumbing line extending to the rinsate reservoir 816 in FIG. 8 is an example of the second system interface.

The agricultural sprayer cleaning assembly 800 includes a cleaning control system, such as the system 700 shown in FIG. 7. The cleaning control system 700 is coupled with one or more sensors and actuators of the cleaning assembly 800 including, but not limited to, one or more of sensors (constituent, flow, pressure) or actuators (pumps, valves). The cleaning control system 700 includes a cleaning controller 702 having a procedure index 710 with cleaning procedures and corresponding actuation instructions for implementation of cleaning procedures with the cleaning assembly 800. Examples of some cleaning procedures are provided in the description of FIG. 7. The cleaning procedures include one or more procedure characteristics or features, such as, but not limited to, procedure type, feedback control specifications, procedure counter, procedure timer, system volume, cleaning agent ate, cleaning agent application quantity, rinsate reservoir volume, dwell time, agitation or recirculation specifications or the like. The procedure index 710 provides the cleaning controller 702 with specifications for actuation and coordination of actuation of the various actuators (valves, pumps or the like) to control one or more of delivery of cleaning agent, dilution agent, flushing of rinsate, collection of rinsate or the like. In various examples, the procedure index 710 specifies sensors, such as constituent sensors, flow sensors, pressure sensors or the like, for monitoring the cleaning assembly 800.

After cleaning, the agricultural sprayer cleaning assembly 800 optionally includes one or more of an injection product reservoir 808 or carrier fluid reservoir 804 as previously described. The injection product reservoir 808 and carrier fluid reservoir 804 having a replacement agricultural product or carrier fluid for use with the sprayer system 200. In one example, the carrier fluid is delivered from the carrier fluid reservoir 804 to the carrier fluid reservoir 201 of the sprayer system 200 through the system interface 802. In another example, the replacement injection product is delivered from the injection product reservoir 808 to the injection product reservoir 210 of the sprayer system 200 (e.g., through the system interface 802). A nurse truck having the cleaning assembly 800 is thereby configured to clean and initialize the agricultural sprayer system 200 onsite for another spraying operation.

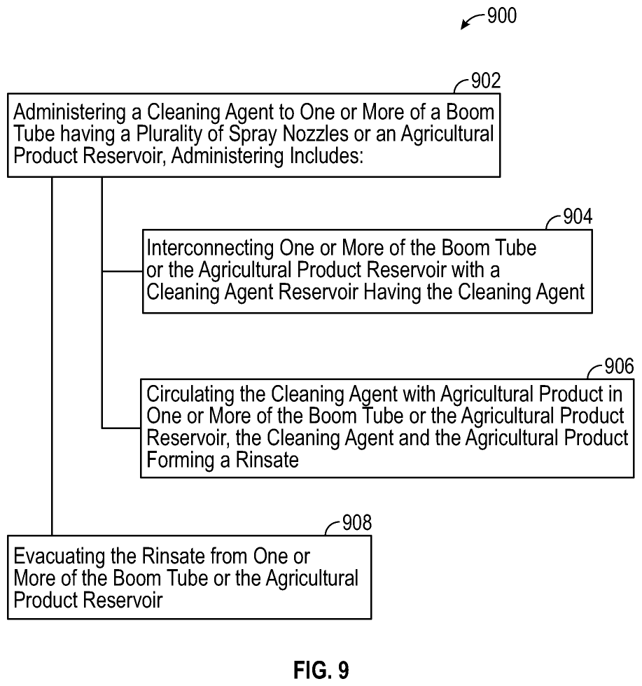

FIG. 9 is a block diagram showing one example of a method 900 for cleaning an agricultural sprayer, such as the sprayer system 200 shown in FIG. 2. In describing the method 900, reference is made to one or more components, features, functions, steps or the like previously described herein. Where convenient, reference is made to the components, features, functions, steps or the like with reference numerals. Reference numerals provided are exemplary and are not exclusive. For instance, components, features, functions, steps or the like described in the method 900 include, but are not limited to, corresponding numbered elements provided herein, other corresponding features described herein (both numbered and unnumbered) as well as their equivalents.

At 902 the method 900 includes administering a cleaning agent to one or more of a boom tube 204 (also referred to herein as a sprayer boom) having a plurality of spray nozzles 212 or an agricultural product reservoir 201. Administering the cleaning agent includes at 904 interconnecting one or more of the boom tube 204 or the agricultural product reservoir 201 with a cleaning agent reservoir 216 having the cleaning agent. At 906, the cleaning agent is circulated with agricultural product, such as agricultural product residue, in one or more of the boom tube 204 or the agricultural product reservoir 201. The cleaning agent and the agricultural product form a rinsate.

At 908 the rinsate is evacuated from one or more of the boom tube 204 or the agricultural product reservoir 201. In one example, the rinsate is directed into a rinsate reservoir 220 (or optionally the carrier fluid reservoir 201). In another example, the rinsate is flushed from the sprayer system 200, for instance through the sprayer nozzles 212.

Several options for the method 900 follow. In one example, the method 900 includes arresting communication between the agricultural product reservoir and the boom tube. Arresting of communication permits the cleaning of portions of the sprayer system 200, for instance while using plumbing that is otherwise used for a spraying operation.

In another example, administering the cleaning agent includes administering a specified quantity of the cleaning agent, for instance based on control by a cleaning controller 702 implementing a cleaning procedure with one or more actuators, such as valves, pumps or the like. Optionally, one or more constituent sensors (e.g., constituent sensors, flow meters, pressure sensors or the like) monitor the cleaning assembly 202 to permit administration of the specified quantity. In yet another example, administering the specified quantity of the cleaning agent includes administering a specified quantity of the cleaning agent corresponding to a plumbing volume of one or more of the boom tube 204 or the agricultural product reservoir 201. For example, the cleaning controller includes a procedure index 710 having the volumes for components of the sprayer system 200, and the quantity of cleaning agent is determined based on those volumes.

Optionally, the method 900 includes a constituent sensor 226 (e.g., one or more sensors) in communication with one or more of the boom tube 204 or the agricultural product reservoir 201, the constituent sensor 226 is configured to monitor one or more constituent characteristics of the rinsate. In another example, administering the specified quantity of the cleaning agent includes administering the specified quantity of the cleaning agent based on monitoring of the one or more constituent characteristics, such as characteristics of the agricultural product, product residue, rinsate, intermediates or the like.

In another example, the method 900 includes comparing the monitored one or more constituent characteristics with one or more constituent thresholds, for instance provided with the threshold index 712 of the cleaning controller 702. Optionally, administering the specified quantity of the cleaning agent includes administering the specified quantity of the cleaning agent based on the comparison between the monitored constituent characteristics and the one or more constituent thresholds.

In an additional example, circulating the cleaning agent with the agricultural product includes recirculating the cleaning agent with the agricultural product in a recirculation loop of the boom tube 204 including the boom tube 204 and a recirculation bridge 230. In another example, circulating the cleaning agent with the agricultural product in or more of the boom tube 204 or the agricultural product reservoir 201 (and its associated plumbing) includes circulating the cleaning agent with the agricultural product in the agricultural product reservoir 201 followed by the boom tube 204.

In another example, evacuating the rinsate includes flushing the rinsate from one or more of the boom tube 204 or the agricultural product reservoir 201 (also referred to as a carrier fluid reservoir). For instance, the boom tubes 204 include sprayer nozzles 212 to facilitate flushing. Optionally, the agricultural product reservoir 201 includes a drain to facilitate flushing.

Optionally, the method 900 includes connecting an agricultural sprayer cleaning assembly 800 with the agricultural sprayer, the agricultural sprayer cleaning assembly 800 having the cleaning agent reservoir 810 and at least one system interface 802 configured for coupling with plumbing of the agricultural sprayer including the boom tube and agricultural product reservoir.

### VARIOUS NOTES AND ASPECTS

Aspect 1 can include subject matter such as an agricultural sprayer comprising: an agricultural product reservoir configured to contain an agricultural product; a sprayer boom configured to apply the agricultural product through a plurality of spray nozzles, the sprayer boom includes: a boom tube in communication with the agricultural product reservoir; and the plurality of spray nozzles in communication with the boom tube, wherein each of the spray nozzles of the plurality of spray nozzles is configured to spray the agricultural product; an agricultural sprayer cleaning assembly in communication with at least the boom tube and the plurality of spray nozzles, the agricultural sprayer cleaning assembly including: a cleaning agent reservoir configured to contain a cleaning agent; and a cleaning agent pump in communication with the cleaning agent reservoir and the boom tube; and wherein the agricultural sprayer includes application and cleaning configurations: in the application configuration the boom tube and the sprayer nozzles are in communication with the agricultural product reservoir and are isolated from the cleaning agent reservoir; and in the cleaning configuration one or more of the boom tube, the sprayer nozzles or the agricultural product reservoir are in communication with the cleaning agent reservoir, and the cleaning agent is delivered with the cleaning agent pump.

Aspect 2 can include, or can optionally be combined with the subject matter of Aspect 1, to optionally include wherein in the cleaning configuration the cleaning agent is recirculated through the boom tube.

Aspect 3 can include, or can optionally be combined with the subject matter of one or any combination of Aspects 1 or 2 to optionally include wherein in the cleaning configuration the cleaning agent is circulated through the agricultural product reservoir.

Aspect 4 can include, or can optionally be combined with the subject matter of one or any combination of Aspects 1-3 to optionally include wherein the cleaning configuration includes a first cleaning configuration and a second cleaning configuration: in the first cleaning configuration the cleaning agent is circulated through the boom tube; and in the second cleaning configuration the cleaning agent is circulated through the agricultural product reservoir.

Aspect 5 can include, or can optionally be combined with the subject matter of one or any combination of Aspects 1-4 to optionally include wherein circulation of the cleaning agent includes recirculation of the cleaning agent.

Aspect 6 can include, or can optionally be combined with the subject matter of Aspects 1-5 to optionally include wherein the agricultural product reservoir includes: a carrier fluid reservoir configured to contain a carrier fluid; an injection product reservoir configured to contain an injection product.

Aspect 7 can include, or can optionally be combined with the subject matter of Aspects 1-6 to optionally include an injection pump in communication with the injection product reservoir, and the injection pump is configured to inject the injection product to the carrier fluid, wherein the agricultural product includes the carrier fluid and the injection product.

Aspect 8 can include, or can optionally be combined with the subject matter of Aspects 1-7 to optionally include wherein the sprayer cleaning system includes: a constituent sensor configured to monitor one or more constituent characteristics of the agricultural product or rinsate of the agriculture product in the agricultural product reservoir or boom tube; and a controller in communication with the constituent sensor and the cleaning agent pump, and the controller is configured to operate the cleaning agent pump and the administration of the cleaning agent based on the monitored one or more constituent characteristics.

Aspect 9 can include, or can optionally be combined with the subject matter of Aspects 1-8 to optionally include wherein the controller includes a constituent comparator, the constituent comparator compares the monitored one or more constituent characteristics with corresponding one or more constituent thresholds, and the controller is configured to operate the cleaning agent pump and the administration of the cleaning agent based on the comparison.

Aspect 10 can include, or can optionally be combined with the subject matter of Aspects 1-9 to optionally include wherein the cleaning system includes a rinsate reservoir configured to receive rinsate of the agricultural product, and in the cleaning configuration the rinsate reservoir is in communication with one or more of the boom tube, the plurality of spray nozzles or the agricultural product reservoir.

Aspect 11 can include, or can optionally be combined with the subject matter of Aspects 1-10 to optionally include the cleaning agent, and the cleaning agent includes a neutralizing agent configured to neutralize the agricultural product.

Aspect 12 can include, or can optionally be combined with the subject matter of Aspects 1-11 to optionally include the cleaning agent, and the cleaning agent includes a diluting agent configured to dilute the agricultural product.

Aspect 13 can include, or can optionally be combined with the subject matter of Aspects 1-12 to optionally include n agricultural sprayer cleaning assembly comprising: a cleaning agent reservoir configured to contain a cleaning agent; a rinsate reservoir configured to receive rinsate formed by the cleaning agent and an agricultural product; a system interface in selective communication with the rinsate reservoir or the cleaning agent reservoir, wherein the system interface is configured to couple with agricultural sprayer plumbing; and a cleaning control system configured to clean the agricultural sprayer plumbing, the cleaning control system includes: a constituent sensor configured to monitor one or more constituent characteristics of the rinsate; a cleaning actuator coupled with the cleaning agent reservoir, wherein the cleaning actuator is configured to control administration of the cleaning agent to the agricultural sprayer plumbing through the system interface; and a cleaning controller in communication with the constituent sensor and the cleaning actuator, wherein the cleaning controller is configured to control the cleaning actuator based on the monitored one or more constituent characteristics.

Aspect 14 can include, or can optionally be combined with the subject matter of Aspects 1-13 to optionally include wherein the constituent sensor is coupled with the system interface.

Aspect 15 can include, or can optionally be combined with the subject matter of Aspects 1-14 to optionally include the agricultural sprayer plumbing, and the agricultural sprayer plumbing includes at least one boom tube and a plurality of spray nozzles in communication with the boom tube; and wherein the constituent sensor is coupled with the at least one boom tube.

Aspect 16 can include, or can optionally be combined with the subject matter of Aspects 1-15 to optionally include the agricultural sprayer plumbing, and the agricultural sprayer plumbing includes an agricultural product reservoir, at least one boom tube in communication with the agricultural product reservoir and a plurality of spray nozzles in communication with the boom tube; and wherein the constituent sensor includes at least first and second constituent sensors, the first constituent sensor is coupled with the at least one boom tube, and the second constituent sensor is coupled with the agricultural product reservoir or tubing in communication with the agricultural product reservoir.

Aspect 17 can include, or can optionally be combined with the subject matter of Aspects 1-16 to optionally include wherein the cleaning controller includes a constituent comparator, and the constituent comparator is configured to compare the monitored one or more constituent characteristics with one or more constituent thresholds.

Aspect 18 can include, or can optionally be combined with the subject matter of Aspects 1-17 to optionally include wherein the cleaning controller includes a threshold index having the one or more constituent thresholds, and the one or more constituent thresholds include one or more of composition thresholds or concentration thresholds of rinsate, agricultural products, injection products of an agricultural product or cleaning agents.

Aspect 19 can include, or can optionally be combined with the subject matter of Aspects 1-18 to optionally include wherein the cleaning controller is configured to control the cleaning actuator based on the comparison of the monitored one or more constituent characteristics with the one or more constituent thresholds.

Aspect 20 can include, or can optionally be combined with the subject matter of Aspects 1-19 to optionally include wherein the cleaning controller includes a procedure index having one or more cleaning procedures, and the cleaning controller is configured to control the cleaning actuator based on the monitored one or more constituent characteristics and a selected cleaning procedure of the one or more cleaning procedures.

Aspect 21 can include, or can optionally be combined with the subject matter of Aspects 1-20 to optionally include a rinsate reservoir in communication with the system interface; wherein the cleaning control system includes a rinsate actuator coupled with the rinsate reservoir, and the rinsate actuator is configured to control delivery of the rinsate to the rinsate reservoir from the agricultural sprayer plumbing.

Aspect 22 can include, or can optionally be combined with the subject matter of Aspects 1-21 to optionally include wherein the cleaning controller is configured to control the rinsate actuator based on the monitored one or more constituent characteristics.

Aspect 23 can include, or can optionally be combined with the subject matter of Aspects 1-22 to optionally include wherein the cleaning control system includes an air actuator coupled with a source of compressed air, wherein the air actuator is configured to control administration of compressed air to the agricultural sprayer plumbing through the system interface and correspondingly control evacuation of the rinsate from the agricultural sprayer plumbing.

Aspect 24 can include, or can optionally be combined with the subject matter of Aspects 1-23 to optionally include a method for cleaning an agricultural sprayer comprising: administering a cleaning agent to one or more of a boom tube having a plurality of spray nozzles or an agricultural product reservoir, administering includes: interconnecting one or more of the boom tube or the agricultural product reservoir with a cleaning agent reservoir having the cleaning agent; and circulating the cleaning agent with agricultural product in one or more of the boom tube or the agricultural product reservoir, the cleaning agent and the agricultural product forming a rinsate; and evacuating the rinsate from one or more of the boom tube or the agricultural product reservoir.

Aspect 25 can include, or can optionally be combined with the subject matter of Aspects 1-24 to optionally include arresting communication between the agricultural product reservoir and the boom tube.

Aspect 26 can include, or can optionally be combined with the subject matter of Aspects 1-25 to optionally include wherein administering the cleaning agent includes administering a specified quantity of the cleaning agent.

Aspect 27 can include, or can optionally be combined with the subject matter of Aspects 1-26 to optionally include wherein administering the specified quantity of the cleaning agent includes administering a specified quantity of the cleaning agent corresponding to a plumbing volume of one or more of the boom tube or the agricultural product reservoir.

Aspect 28 can include, or can optionally be combined with the subject matter of Aspects 1-27 to optionally include a constituent sensor in communication with one or more of the boom tube or the agricultural product reservoir, the constituent sensor configured to monitor one or more constituent characteristics of the rinsate; and wherein administering the specified quantity of the cleaning agent includes administering the specified quantity of the cleaning agent based on monitoring of the one or more constituent characteristics.

Aspect 29 can include, or can optionally be combined with the subject matter of Aspects 1-28 to optionally include comparing the monitored one or more constituent characteristics with one or more constituent thresholds; and wherein administering the specified quantity of the cleaning agent includes administering the specified quantity of the cleaning agent based on the comparison.

Aspect 30 can include, or can optionally be combined with the subject matter of Aspects 1-29 to optionally include wherein circulating the cleaning agent with the agricultural product includes recirculating the cleaning agent with the agricultural product in a recirculation loop of the boom tube including the boom tube and a recirculation bridge.

Aspect 31 can include, or can optionally be combined with the subject matter of Aspects 1-30 to optionally include wherein circulating the cleaning agent with the agricultural product in or more of the boom tube or the agricultural product reservoir includes circulating the cleaning agent with the agricultural product in the agricultural product reservoir followed by the boom tube.

Aspect 32 can include, or can optionally be combined with the subject matter of Aspects 1-31 to optionally include wherein evacuating the rinsate includes delivering the rinsate to a rinsate reservoir.

Aspect 33 can include, or can optionally be combined with the subject matter of Aspects 1-32 to optionally include wherein the rinsate reservoir includes the agricultural product reservoir.

Aspect 34 can include, or can optionally be combined with the subject matter of Aspects 1-33 to optionally include wherein evacuating the rinsate includes flushing the rinsate from one or more of the boom tube or the agricultural product reservoir.

Aspect 35 can include, or can optionally be combined with the subject matter of Aspects 1-34 to optionally include connecting an agricultural sprayer cleaning assembly with the agricultural sprayer, the agricultural sprayer cleaning assembly having the cleaning agent reservoir and at least one system interface configured for coupling with plumbing of the agricultural sprayer including the boom tube and agricultural product reservoir.

Each of these non-limiting examples can stand on its own, or can be combined in various permutations or combinations with one or more of the other examples.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method aspects or examples described herein can be machine or computer-implemented at least in part. Some aspects or examples can include a computer-readable medium or machine-readable medium encoded with instructions operable to configure an electronic device to perform methods as described in the above aspects or examples. An implementation of such methods can include code, such as microcode, assembly language code, a higher-level language code, or the like. Such code can include computer readable instructions for performing various methods. The code may form portions of computer program products. Further, in an aspect or example, the code can be tangibly stored on one or more volatile, non-transitory, or non-volatile tangible computer-readable media, such as during execution or at other times. Aspects or examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. An agricultural sprayer comprising:
an agricultural product reservoir configured to contain an agricultural product;
a sprayer boom configured to apply the agricultural product through a plurality of spray nozzles, the sprayer boom includes:
a boom tube in communication with the agricultural product reservoir; and
the plurality of spray nozzles in communication with the boom tube, wherein each of the spray nozzles of the plurality of spray nozzles is configured to spray the agricultural product;
an agricultural sprayer cleaning assembly in communication with at least the boom tube and the plurality of spray nozzles, the agricultural sprayer cleaning assembly including:
a cleaning agent reservoir configured to contain a cleaning agent; and
a cleaning agent pump in communication with the cleaning agent reservoir and the boom tube; and
wherein the agricultural sprayer includes application and cleaning configurations:
in the application configuration the boom tube and the sprayer nozzles are in communication with the agricultural product reservoir and are isolated from the cleaning agent reservoir; and
in the cleaning configuration one or more of the boom tube, the sprayer nozzles or the agricultural product reservoir are in communication with the cleaning agent reservoir, and the cleaning agent is delivered with the cleaning agent pump to one or more of the boom tube, the sprayer nozzles or the agricultural product reservoir.

2. The agricultural sprayer of claim 1, wherein in the cleaning configuration the cleaning agent is recirculated through the boom tube.

3. The agricultural sprayer of claim 1, wherein in the cleaning configuration the cleaning agent is circulated through the agricultural product reservoir.

4. The agricultural sprayer of claim 1, wherein the cleaning configuration includes a first cleaning configuration and a second cleaning configuration:
in the first cleaning configuration the cleaning agent is circulated through the boom tube; and
in the second cleaning configuration the cleaning agent is circulated through the agricultural product reservoir.

5. The agricultural sprayer of claim 1, wherein circulation of the cleaning agent includes recirculation of the cleaning agent.

6. The agricultural sprayer of claim 1, wherein the agricultural product reservoir includes:
a carrier fluid reservoir configured to contain a carrier fluid;
an injection product reservoir configured to contain an injection product.

7. The agricultural sprayer of claim 6 comprising an injection pump in communication with the injection product reservoir, and the injection pump is configured to inject the injection product to the carrier fluid, wherein the agricultural product includes the carrier fluid and the injection product.

8. The agricultural sprayer of claim 1, wherein the sprayer cleaning system includes:
a constituent sensor configured to monitor one or more constituent characteristics of the agricultural product or rinsate of the agriculture product in the agricultural product reservoir or boom tube; and
a controller in communication with the constituent sensor and the cleaning agent pump, and the controller is configured to operate the cleaning agent pump and the administration of the cleaning agent based on the monitored one or more constituent characteristics.

9. The agricultural sprayer of claim 8, wherein the controller includes a constituent comparator, the constituent comparator compares the monitored one or more constituent characteristics with corresponding one or more constituent thresholds, and the controller is configured to operate the cleaning agent pump and the administration of the cleaning agent based on the comparison.

10. The agricultural sprayer of claim 1, wherein the cleaning system includes a rinsate reservoir configured to receive rinsate of the agricultural product, and in the cleaning configuration the rinsate reservoir is in communication with one or more of the boom tube, the plurality of spray nozzles or the agricultural product reservoir.

11. The agricultural sprayer of claim 1 comprising the cleaning agent, and the cleaning agent includes a neutralizing agent configured to neutralize the agricultural product.

12. The agricultural sprayer of claim 1 comprising the cleaning agent, and the cleaning agent includes a diluting agent configured to dilute the agricultural product.

13. An agricultural sprayer cleaning assembly comprising:
a cleaning agent reservoir configured to contain a cleaning agent;
a rinsate reservoir configured to receive rinsate formed by the cleaning agent and an agricultural product;
a system interface in selective communication with the rinsate reservoir or the cleaning agent reservoir, wherein the system interface is configured to couple with agricultural sprayer plumbing; and
a cleaning control system configured to clean the agricultural sprayer plumbing, the cleaning control system includes:
a constituent sensor configured to monitor one or more constituent characteristics of the rinsate;
a cleaning actuator coupled with the cleaning agent reservoir, wherein the cleaning actuator is configured to control administration of the cleaning agent to the agricultural sprayer plumbing through the system interface; and
a cleaning controller in communication with the constituent sensor and the cleaning actuator, wherein the cleaning controller is configured to control the cleaning actuator based on the monitored one or more constituent characteristics.

14. The agricultural sprayer cleaning assembly of claim 13, wherein the constituent sensor is coupled with the system interface.

15. The agricultural sprayer cleaning assembly of claim 13 comprising the agricultural sprayer plumbing, and the agricultural sprayer plumbing includes at least one boom tube and a plurality of spray nozzles in communication with the boom tube; and
wherein the constituent sensor is coupled with the at least one boom tube.

16. The agricultural sprayer cleaning assembly of claim 13 comprising the agricultural sprayer plumbing, and the agricultural sprayer plumbing includes an agricultural product reservoir, at least one boom tube in communication with the agricultural product reservoir and a plurality of spray nozzles in communication with the boom tube; and
wherein the constituent sensor includes at least first and second constituent sensors, the first constituent sensor is coupled with the at least one boom tube, and the second constituent sensor is coupled with the agricultural product reservoir or tubing in communication with the agricultural product reservoir.

17. The agricultural sprayer cleaning assembly of claim 13, wherein the cleaning controller includes a constituent comparator, and the constituent comparator is configured to compare the monitored one or more constituent characteristics with one or more constituent thresholds.

18. The agricultural sprayer cleaning assembly of claim 17, wherein the cleaning controller includes a threshold index having the one or more constituent thresholds, and the one or more constituent thresholds include one or more of composition thresholds or concentration thresholds of rinsate, agricultural products, injection products of an agricultural product or cleaning agents.

19. The agricultural sprayer cleaning assembly of claim 17, wherein the cleaning controller is configured to control the cleaning actuator based on the comparison of the monitored one or more constituent characteristics with the one or more constituent thresholds.

20. The agricultural sprayer cleaning assembly of claim 13, wherein the cleaning controller includes a procedure index having one or more cleaning procedures, and the cleaning controller is configured to control the cleaning actuator based on the monitored one or more constituent characteristics and a selected cleaning procedure of the one or more cleaning procedures.

21. The agricultural sprayer cleaning assembly of claim 13, comprising a rinsate reservoir in communication with the system interface;
wherein the cleaning control system includes a rinsate actuator coupled with the rinsate reservoir, and the rinsate actuator is configured to control delivery of the rinsate to the rinsate reservoir from the agricultural sprayer plumbing.

22. The agricultural sprayer cleaning assembly of claim 21, wherein the cleaning controller is configured to control the rinsate actuator based on the monitored one or more constituent characteristics.

23. The agricultural sprayer cleaning assembly of claim 13, wherein the cleaning control system includes an air actuator coupled with a source of compressed air, wherein the air actuator is configured to control administration of compressed air to the agricultural sprayer plumbing through the system interface and correspondingly control evacuation of the rinsate from the agricultural sprayer plumbing.

24. A method for cleaning an agricultural sprayer comprising:
administering a cleaning agent to one or more of a boom tube having a plurality of spray nozzles or an agricultural product reservoir, administering includes:
interconnecting one or more of the boom tube or the agricultural product reservoir with a cleaning agent reservoir having the cleaning agent; and
circulating the cleaning agent with agricultural product in one or more of the boom tube or the agricultural product reservoir, the cleaning agent and the agricultural product forming a rinsate; and
evacuating the rinsate from one or more of the boom tube or the agricultural product reservoir.

25. The method of claim 24 comprising arresting communication between the agricultural product reservoir and the boom tube.

26. The method of claim 24, wherein administering the cleaning agent includes administering a specified quantity of the cleaning agent.

27. The method of claim 26, wherein administering the specified quantity of the cleaning agent includes administering a specified quantity of the cleaning agent corresponding to a plumbing volume of one or more of the boom tube or the agricultural product reservoir.

28. The method of claim 26 comprising a constituent sensor in communication with one or more of the boom tube or the agricultural product reservoir, the constituent sensor configured to monitor one or more constituent characteristics of the rinsate; and
wherein administering the specified quantity of the cleaning agent includes administering the specified quantity of the cleaning agent based on monitoring of the one or more constituent characteristics.

29. The method of claim 28 comprising comparing the monitored one or more constituent characteristics with one or more constituent thresholds; and
wherein administering the specified quantity of the cleaning agent includes administering the specified quantity of the cleaning agent based on the comparison.

30. The method of claim 24, wherein circulating the cleaning agent with the agricultural product includes recirculating the cleaning agent with the agricultural product in a recirculation loop of the boom tube including the boom tube and a recirculation bridge.

31. The method of claim 24, wherein circulating the cleaning agent with the agricultural product in or more of the boom tube or the agricultural product reservoir includes circulating the cleaning agent with the agricultural product in the agricultural product reservoir followed by the boom tube.

32. The method of claim 24, wherein evacuating the rinsate includes delivering the rinsate to a rinsate reservoir.

33. The method of claim 32, wherein the rinsate reservoir includes the agricultural product reservoir.

34. The method of claim 24, wherein evacuating the rinsate includes flushing the rinsate from one or more of the boom tube or the agricultural product reservoir.

35. The method of claim 24 comprising connecting an agricultural sprayer cleaning assembly with the agricultural sprayer, the agricultural sprayer cleaning assembly having the cleaning agent reservoir and at least one system interface configured for coupling with plumbing of the agricultural sprayer including the boom tube and agricultural product reservoir.
